(19) United States
(12) Patent Application Publication
(10) Pub. No.: US 2015/0287177 A1
(43) Pub. Date: Oct. 8, 2015

(54) IMAGE MEASURING DEVICE

(71) Applicant: MITUTOYO CORPORATION, Kanagawa (JP)

(72) Inventors: Makoto KAIEDA, Miyazaki (JP); Akira TAKADA, Yokohama (JP)

(73) Assignee: MITUTOYO CORPORATION, Kanagawa (JP)

(21) Appl. No.: 14/680,356

(22) Filed: Apr. 7, 2015

(30) Foreign Application Priority Data
Apr. 8, 2014 (JP) 2014-079782

(51) Int. Cl. G06T 7/00; G01B 11/26; G06K 9/62; G01B 11/00

(52) U.S. Cl. CPC G06T 7/001; G01B 11/002; G01B 11/26; G06K 9/6201; G06T 2207/30164

(57) ABSTRACT

An image measuring device having an XY stage capable of moving along orthogonal XY axes includes an imaging capturer that takes an image of a plurality of same shape measured objects placed onto the XY stage, a specifier that specifies a location and a rotation angle of each measured object by using preregistered image patterns and through pattern matching, and a detector that measures a dimension of each measured object using at least one of the specified location and rotation angle and detects coordinate data of each measured object on the XY stage.

### CROSS-REFERENCE TO RELATED APPLICATIONS

The present application claims priority under 35 U.S.C. §119 of Japanese Application No. 2014-079782, filed on Apr. 8, 2014, the disclosure of which is expressly incorporated by reference herein in its entirety.

### BACKGROUND OF THE INVENTION

1. Field of the Invention

The present invention is related to an image measuring device, and in particular relates to an image measuring device suited for measuring a plurality of same shape work pieces that are placed on the stage of the device.

2. Description of Related Art

According to Japanese Patent Laid-open Publication H11-351824, the automation of measurement processes is performed by a measurement procedure file when using a CNC (Computer Numerical Control) image measuring apparatus to measure the dimensions etc. of a plurality of same shape work pieces. The measurement procedure file is recorded and created simultaneously as an operator progresses through a sequence of measuring operations on a work piece or master work piece. The measurement procedure file is then recorded within a computer as a part program file. For subsequent work pieces, operations such as stage displacement and auto focus, image acquisition and image processing, as well as various forms of arithmetic processing such as geometric computation are automatically executed according to the recorded measurement procedure file.

A “step & repeat” function is provided as a measuring method for repeatedly measuring a plurality of same shape work pieces when using this type of image measuring apparatus to perform automated measuring processes.

When using the “step & repeat” function, measured objects are placed in a “linear configuration” in which measured objects are placed in relation to each direction of alignment at equal intervals as illustrated in FIG. 1A. The measured objects may also be set in a “circular configuration” in which they are placed circumferentially at equal intervals as illustrated in FIG. 1B. Settings should be determined at the setting screen as illustrated in FIG. 2. In other words, a plurality of measured objects needs to be arranged in a matrix or circular configuration.

Consequently, specialized jigs are prepared for work piece placement when conducting measurements. Repeated measurement processes are realized as the number of work pieces, the number of vertical and horizontal arrangements, and intervals etc. are predetermined.

However, a measurement error occurs at measuring points without work pieces in a case where the number of work pieces placed within the specialized jig does not meet the number of available spaces provided by the jig (in other words, a state in which a work piece is missing from the jig arrangement). This error will also occur upon executing the part program with the number of work pieces set at recording, in such instances as when a discrepancy exists between the number of work pieces present at the time of part program recording and that of execution. Operation for areas omitted from measurement must be designated for excluded steps when executing the part program. Therefore, operation becomes cumbersome when avoiding this problem. For example, as in the case of the Step & Repeat setting screen illustrated in FIGS. 1A and 1B, there is a need to designate skipped areas within the “omitted step” box.

In the case where originally there was no specialized jig, automatic measuring could not be performed by executing the part program when placing a plurality of measured objects onto the stage all at once. Additionally, the location and orientation on the stage had to be accurately consistent each time when placing individual measured objects onto the stage and running automatic measuring through the part program. If these criteria were not met, an error would occur during automatic measuring performed by the part program, precluding automatic measuring from taking place.

### SUMMARY OF THE INVENTION

The present invention is conceived in order to resolve the present problems and to address the issue of improving operability. Operability is improved as repeated measurements may be performed when measuring a plurality of same shape work pieces without arranging work pieces at equal intervals within linear or circular configurations and regardless of work piece positioning.

The present invention is an image measuring device provided with a XY stage capable of moving along orthogonal XY axes. The problem is resolved by providing an imaging capturer, a specifier, and a detector. The imaging capturer takes images of a plurality of same shape measured objects placed on the XY stage. The specifier specifies the location and rotation angle of each measured object through prerecorded image patterns and pattern matching. The detector utilizes a specified location and/or rotation angle to measure the dimensions of each measured object and detects the coordinate values of each measured object on the XY stage.

The coordinate data for measuring the dimensions of each measured object may be set by using the location and/or rotation angle of each measured object specified by the pattern matching.

Additionally, the number of measured objects specified by the pattern matching may be set as the number of repeated processes.

According to the present invention, operability may be improved as repeated measurements can be performed when measuring a plurality of same shape work pieces without arranging work pieces at equal intervals within linear or circular configurations and regardless of work piece positioning. Furthermore, the use of jigs in order to perform measurements is no longer needed.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1A illustrates an example of a linear configuration, and FIG. 1B illustrates a circular configuration on the conventional step & repeat setting screen;

FIG. 2 illustrates an example of work pieces placed at equal intervals on the conventional Step & Repeat setting screen;

FIG. 3 is an oblique perspective that illustrates the overall configuration of the CNC image measuring apparatus according to the present invention;

FIG. 4 is a block figure that illustrates the computer system configuration of the CNC image measuring apparatus according to the present invention;

FIG. 5 is a flow chart that illustrates an embodiment of the process sequence of the CNC image measuring apparatus according to the present invention;

FIG. 6 illustrates a state in which a work piece is recognized by the pattern search of the CNC image measuring apparatus according to the present invention; and

FIG. 7 illustrates an embodiment of the part program command of the CNC image measuring apparatus according to the present invention.

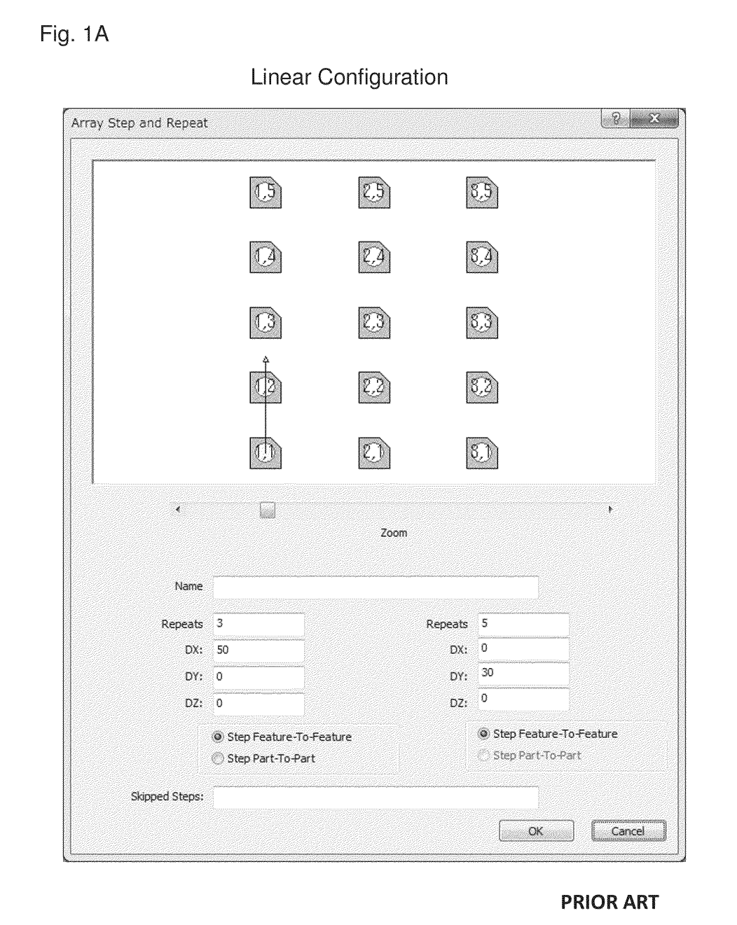

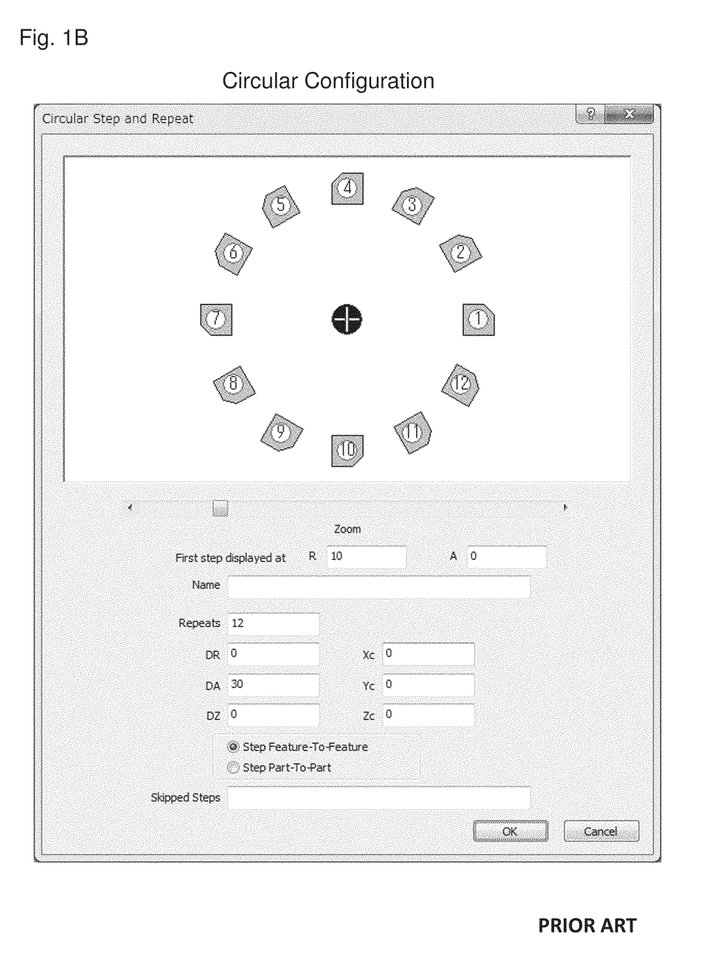

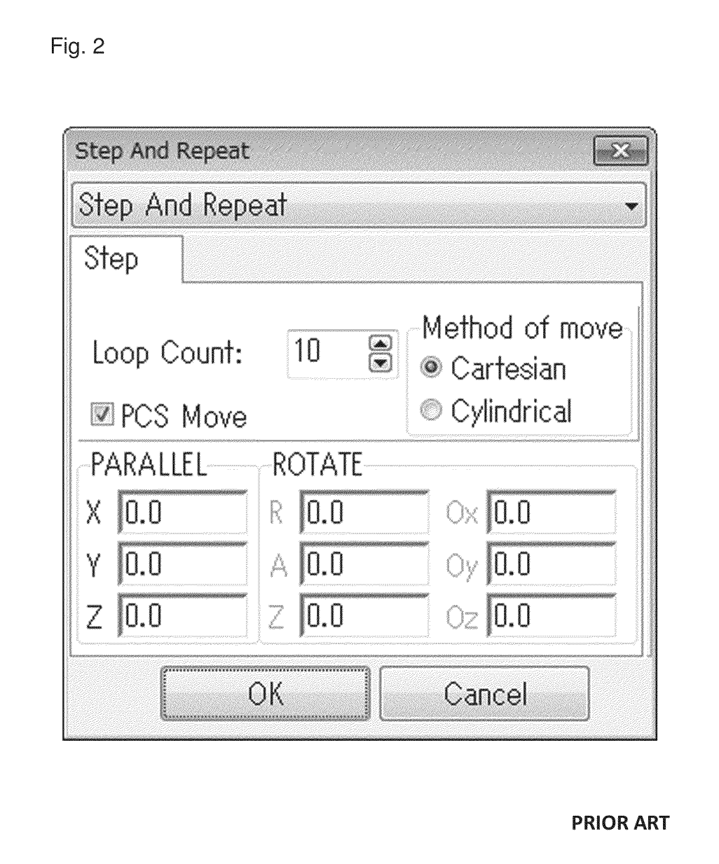

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Below is a detailed explanation of an embodiment of the present invention referencing figures. The present invention is not limited to the contents written in the embodiment below. Additionally, there are elements easily conceivable to a person skilled in the art, those that are intrinsic equivalents or otherwise equal in scope included within the compositional requirements of the embodiment below. The disclosed compositional elements within the written embodiment below may be combined and chosen for usage freely.

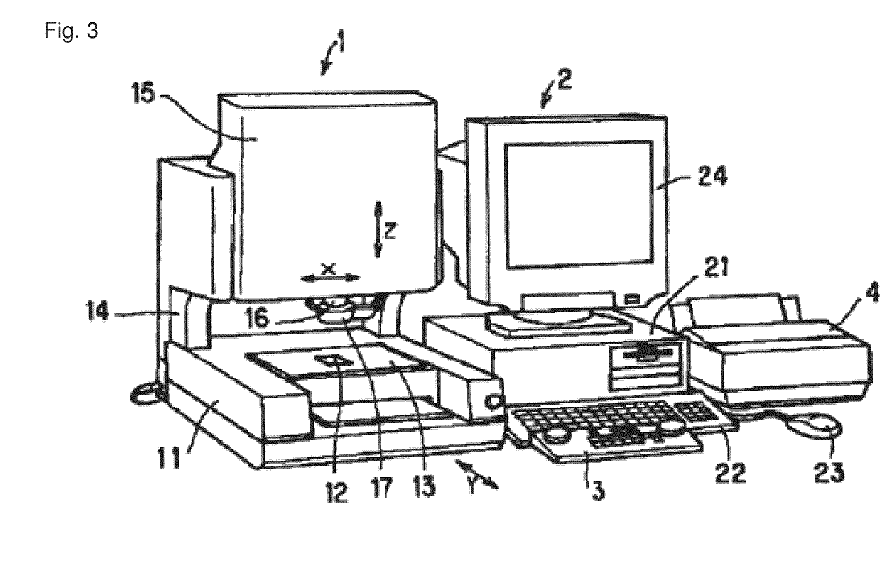

FIG. 3 illustrates the overall configuration of the CNC image measuring apparatus according to the present invention. The apparatus includes a non-contact type image measuring device main body 1, a computer system 2 that processes necessary measurement data as well as driving/controlling the measuring device main body 1, a command input part 3 that manually operates the measuring device main body, and a printer 4 that prints out measurement results.

The measuring device main body 1 includes a stand 11 and a measuring table 13 onto which measured objects, namely work pieces 12 are placed, the measuring table 13 being configured with an XY stage. The measuring table 13 is driven in a Y axis direction by the Y axis drive mechanism. A frame 14 extends upward and is secured by a rear edge portion of the stand 11. Within a cover 15 which extends from the upper portion of the frame 14 to the front, a CCD camera (other cameras besides a CCD may be used) 16 is attached so as to overlook the measuring table 13 from the above. The CCD camera 16 is driven by X and Z axis drive mechanisms and a rotational drive mechanism. A ring shaped illumination apparatus 17 that illuminates the work pieces 12 is provided on a lower edge of the CCD camera 16.

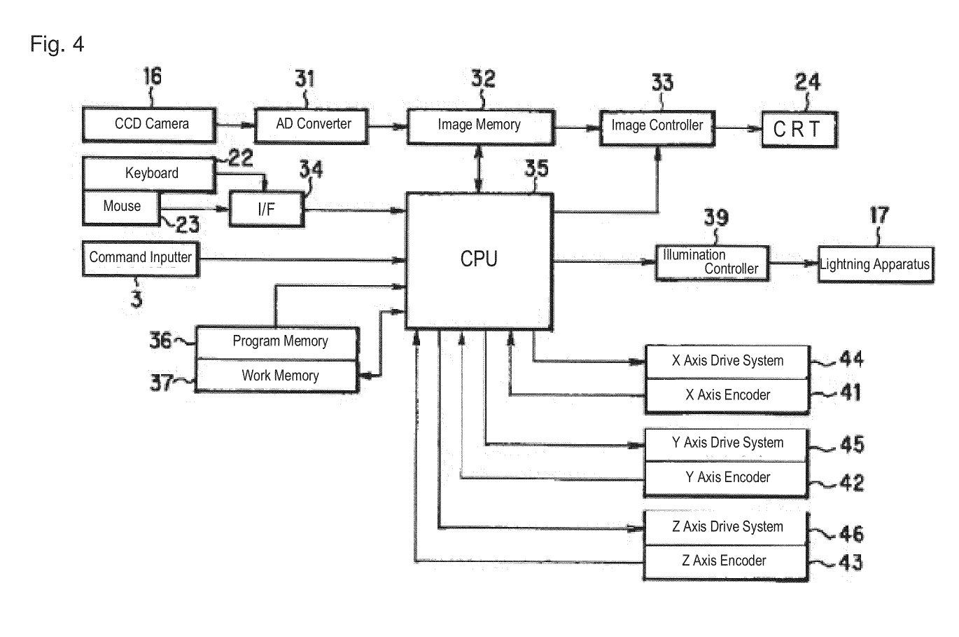

The computer system 2 is provided with and includes a computer main body 21, a keyboard 22, a mouse 23 and a CRT display (other displays such as a LCD may also be used) 24. FIG. 4 illustrates a configuration of this system with the computer main body 21 at the center. An image signal of the work pieces 12 taken by the CCD camera 16 is converted into multi-level image data by the AD converter 31 and stored within the image memory 32. The multi-level image data stored within an image memory 32 is displayed on a CRT display 24 by the controls of a display controller 33. Commands given by an operator via a keyboard 22 and a mouse 23 are transmitted to a CPU 35 through an interface 34. The CPU 35 executes various processes such as stage movement in accordance to commands given by the operator and programs stored within a program memory 36. A work memory 37 provides the CPU 35 with work space for various processes.

An X axis encoder 41 and a Z axis encoder 43 are provided so that the CCD camera 16 may detect locations in the X and Z axis directions. A Y axis encoder 42 is provided so that locations in the Y axis direction on the measuring table 13 may be detected. The output of these encoders 41-43 is received by the CPU 35. Based on received location information and operator commands, the CPU 35 drives the CCD camera 16 in the X and Z axis directions utilizing the X drive system 44 and the Z axis drive system 46. The CPU 35 also drives the measuring table 13 in the Y axis direction utilizing the Y axis drive system 45. The illumination controller 39 generates directed voltage in an analog amount based on the command value generated by the CPU 35 and drives the illumination apparatus 17.

When employing the measuring device according to the present embodiment to measure the shape, dimensions etc. of a plurality of same shape work pieces, a master work piece is measured in recording mode and a measurement procedure file (part program) is created. The measurement procedure file is recorded in the computer system 2 and automatic measuring is performed in accordance to the measurement procedure file in execution mode.

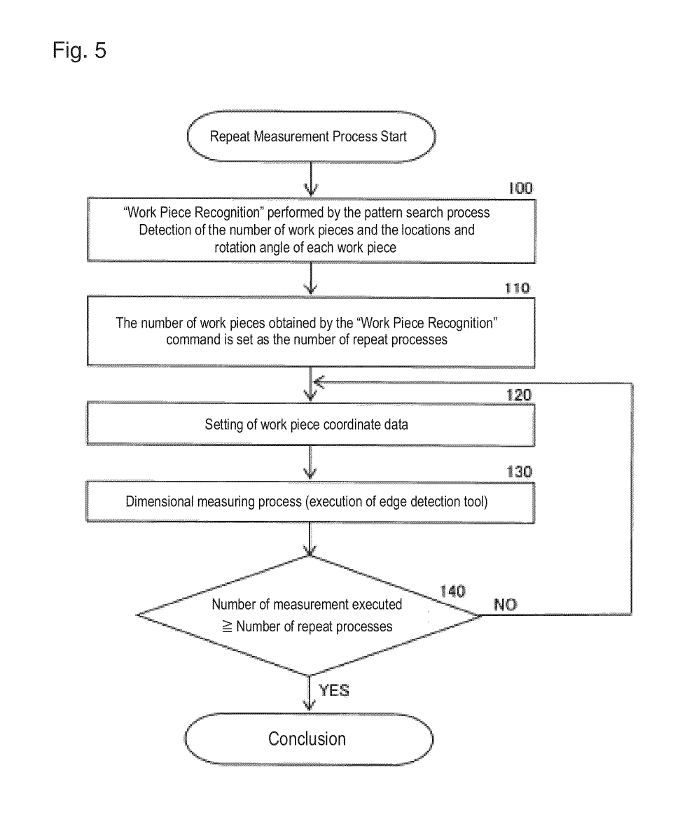

FIG. 5 illustrates the procedure for the repeat process part program according to the present embodiment.

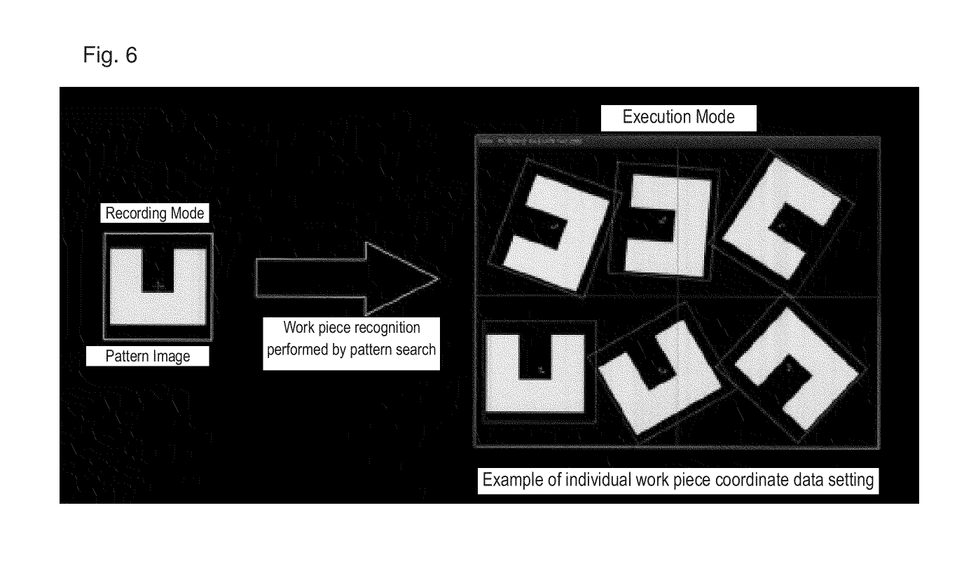

In Step 100, as illustrated in FIG. 6, work pieces are recognized completely within a single screen using a pattern search process that searches for work pieces. The pattern search process uses pattern matching which in turn utilizes master work piece pattern images recorded in recording mode. Upon using the pattern search process, the number of work pieces as well as the location and rotation angle of each work piece can be detected. In this manner, repeat measurement repetitions for single-screen measurements are performed automatically during part program execution. Therefore, the position of each work piece, namely the location and rotation angle, may be arbitrarily determined since the pattern search process is employed.

Subsequently, in Step 110, the number of work pieces acquired during the pattern search process of Step 100 is set as the number of repeat processes.

In Step 120 the work piece coordinate data for measuring the dimensions of each work piece is generated using the location and rotation angle data of each work piece detected during the pattern search process of Step 100. The coordinate data of measured work pieces is automatically set during each repeat process.

In Step 130, using the coordinate data set in Step 120, dimensional measurement processes are performed after executing the in-screen total measuring tool which includes an edge detection tool that detects each work piece. The edge detection tool location and rotation angle is linked to work pieces and is automatically set since the coordinate data is automatically set as well. Therefore, a collective measurement process of a plurality of work pieces is automatically executed when measuring each work piece during a repeat process.

In Step 140 it is determined whether the number of measurement executions surpasses that of repeat processes set in Step 110.

Should the result of Step 140 be determined as negative, the process will return to Step 120 and repeat dimensional measurements.

Meanwhile, should the result of Step 140 be determined as positive the repeat measuring process will conclude.

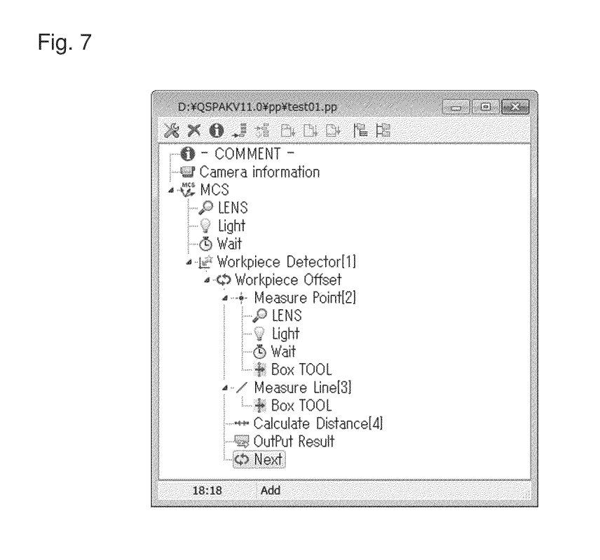

FIG. 7 illustrates an embodiment of the repeat process of a part program.

The number of same shape work pieces to be measured as well as location and rotation angle data is acquired by using the “work piece recognition” command. The coordinate data is set by the previously acquired location and rotation angle data using the “work piece offset” command.

When recording the part program, the operator may register a master work piece with the “work piece recognition” command (pattern search processing) or execute the measure command (register with the edge detection tool).

In this manner the detection process for a plurality of work pieces is automatically processed using the “work piece recognition” command when executing the part program.

In the present embodiment, since a number of repetitions is being requested using the pattern search process, it is not necessary to input the number of work pieces before executing the part program. Therefore, measurements can be performed with extreme ease. Additionally, the number and position of work pieces is not requested so a jig for repeated measuring processes is not necessary.

Further, since the location coordinate values for each work piece can be detected, the distance between each work piece may be requested. For example in the case of a substrate possessing a plurality of holes, the center distance between two holes may be requested. Various geometric computations may also be performed using the coordinate values of each work piece.

Additionally, there is no need to set the coordinate values for the dimensional measurements of each work piece because these values are being set using the work piece location and rotation angle specified by the pattern search process.

The images used by pattern search in the present embodiment may be single or composite images (stitched images) generated from a plurality of images. In other words, should a work piece be so large that its entire image cannot be captured at one time, the entire image can be taken by driving the work stage and splitting the work piece into a plurality of image captures. These fragmented work piece images can then be composited (stitched) into a single image. Dimensional measurements for each pattern detected and locational coordinate values for each pattern within the image may be requested when conducting pattern search on such images. Consequently, it is possible to accurately request the distance between each pattern.

Additionally, the number of work pieces and work piece coordinate data to be measured may be set individually. Furthermore, measured objects are not limited to work pieces.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An image measuring device having an XY stage that is movable along orthogonal XY axes, the image measuring device comprising:
an imaging capturer configured to take an image of a plurality of same shape measured objects placed onto the XY stage;
a specifier configured to specify a location and a rotation angle of each measured object by using preregistered image patterns and through pattern matching; and
a detector configured to measure a dimension of each measured object using at least one of the specified location and rotation angle, the detector further configured to detect coordinate data of each measured object on the XY stage.

2. The image measuring device according to claim 1, wherein coordinate data for the dimensional measurement of each measured object is set using at least one of the specified location and rotation angle of each measured object specified by the pattern matching.

3. The image measuring device according to claim 1, wherein a number of measured objects specified by the pattern matching is set as the number of repeat processes.

4. The image measuring device according to claim 2, wherein a number of measured objects specified by the pattern matching is set as the number of repeat processes.
